(19) United States
(12) Patent Application Publication
(10) Pub. No.: US 2008/0227319 A1
(43) Pub. Date: Sep. 18, 2008

(54) Universal connector

(76) Inventor: Guixian Lu, Pontiac, MI (US)

Correspondence Address: Guixian Lu, 853 Melrose Street, Pontiac, MI, 48340, US

(21) Appl. No.: 11/717,455

(22) Filed: Mar. 14, 2007

(51) Int. Cl. H01R 27/00

(52) U.S. Cl. 439/217

(57) ABSTRACT

This new connector was originally designed for coaxial cables. All connectors are identical. None of them has gender. Any connector will fit any other connector. There are a male sub-connector and a female sub-connector in a universal connector for connection of a wire. There is also a lock to keep two conjunct connectors together. The connection of connectors is shielded as well.

### BACKGROUND OF THE INVENTION

Any connector has a gender: either male or female. A connector can be connected to only another connector with opposite gender. To make a plan for connecting two devices, the user should consider the gender of each end of each cable. Some times an adaptor with the same gender of connectors at both ends is needed to make a connection. When the existing wiring connection needs to be changed, it is inconvenient to consider all the connectors for gender. This happens more often in laboratories.

The present invention provides a single kind of connector without gender. It will make the wiring plan easier and faster especially when supply of parts is short, for example in a ship, airplane, or satellite. When two universal connectors are pushed together, they will be connected and locked together which is easier than making connections for old connectors. The new design of connector will reduce the cost of manufacturing because one set of equipment is needed instead of two. It also will reduce the costs of storage and distribution of connectors because it will reduce the number of items from two to one.

### SUMMARY OF THE INVENTION

The primary objective of the present invention is to replace connectors of both genders with a single kind of connector to make the wiring plan and connection easier. The other objective of the invention is to reduce the cost of manufacturing, storing, and distributing the connectors.

### BRIEF DESCRIPTION OF THE DRAWING

### First Embodiment

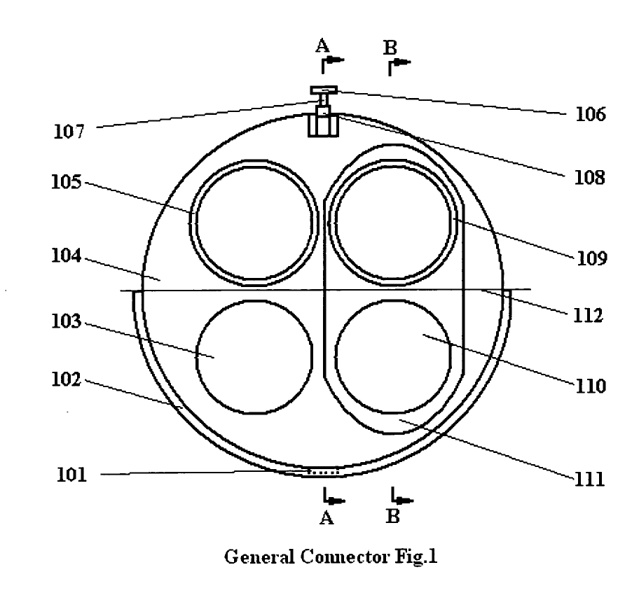

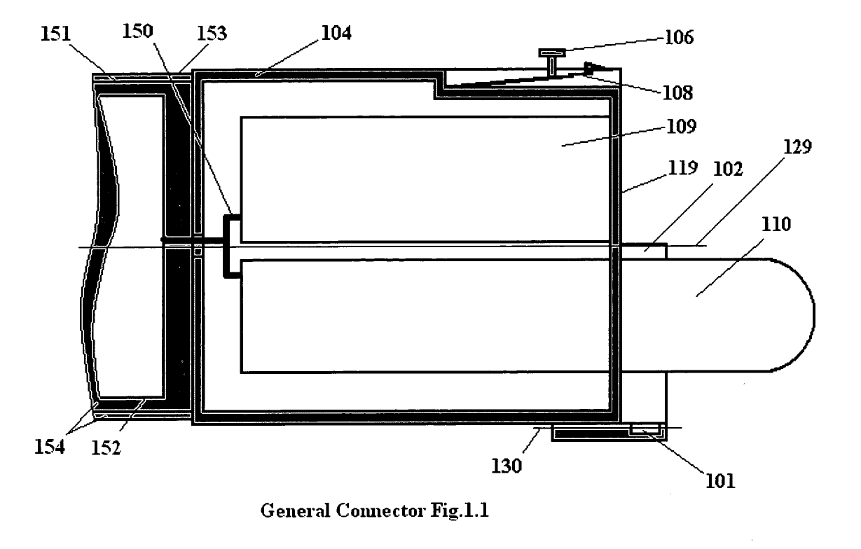

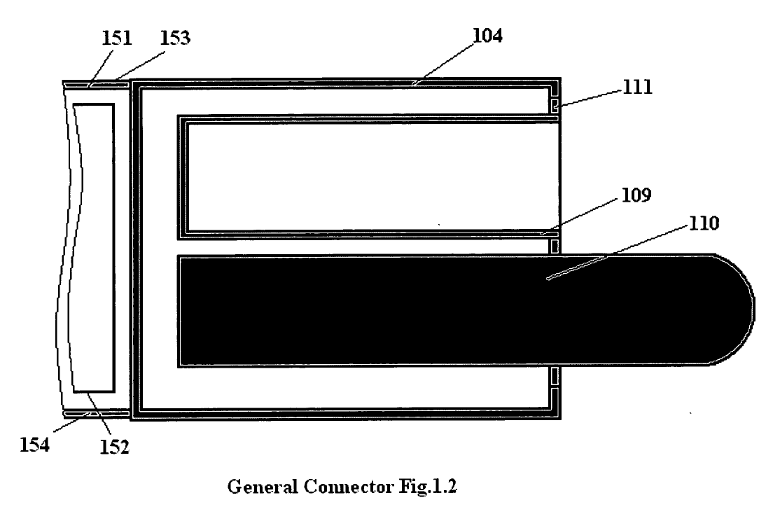

FIG. 1 is a view of the connector from one end of the cable. Item 102 is a protective shield to protect the connectors from corroding material. Item 103 is a male sub-connector for the outer wire of the cable. Item 104 is the body or shell of the universal connector. Item 102 is secured to item 104. Item 105 is a female sub-connector for the outer wire of the cable. Item 106 is a push-button with a rod for pushing a spring item 108 down to release the lock. Item 108 is the spring with a hook at one end and is welded to the body of the connector at the other end. Item 108 will be connected with item 101 (see FIG. 1.1) of the conjunct universal connector when two universal connectors are locked together. Item 108 and item 101 are considered as two parts of the lock. Item 109 is a female sub-connector for the axial wire of the cable. Item 110 is a male sub-connector for the axial wire of the cable. Item 111 is insulation material that electrically separates the axial sub-connectors from the body. Item 112 is an imaginary symmetry plane. Item 109 and 110 are electrically linked to the axial wire of the cable. The rest of the items, except item 111 and 112, are electrically linked to the outer wire of the cable.

FIG. 1.1 shows a cross section, cut at the plane A-A in FIG. 1, with the view to the right after cutting. Item 104 is the body of the connector. Item 106 is the push-button with the rod for pushing the spring item 108 down to release the lock. Item 108 is a spring with a hook at one end and is welded to the body of the connector at the other end. Item 108 will be connected with a notch item 101 of the conjunct universal connector when two universal connectors are locked together. Item 109 is the female sub-connector for the axial wire of the cable. Item 102 is the protective shield. Item 110 is the male sub-connector for the axial wire. Item 101 is the notch. Item 129 is the axis of the connector. Item 130 is a line parallel to item 129. Item 130 is going through item 101. Item 101 will be connected to the spring item 108 of the conjunct universal connector to lock two universal connectors together. The positions of item 101 and item 108 would be symmetrical with the symmetry plane item 112, if item 101 were shifted along line item 130 properly.

FIG. 1.2 shows a cross section, cut at the plane B-B in FIG. 1, with the view to the right after cutting. Item 104 is the body of the connector. Item 111 is insulation material. Item 109 is the female sub-connector for the axial wire of the cable. Item 110 is the male sub-connector for the axial wire of the cable.

### Second Embodiment

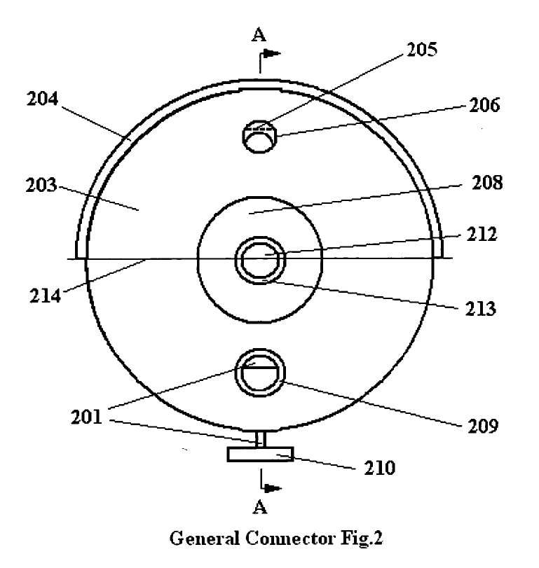

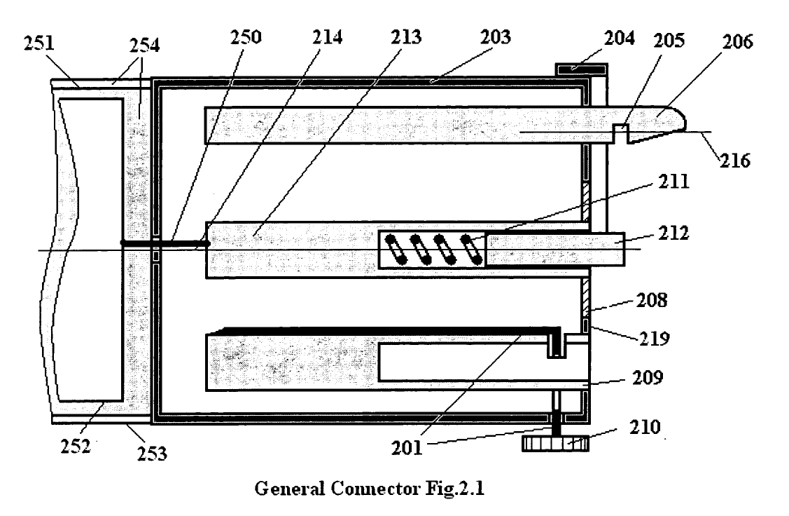

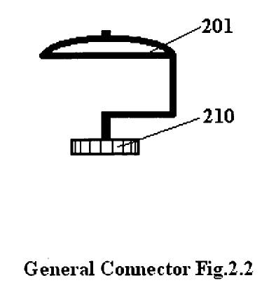

FIG. 2 is a view of the connector from one end of the cable. Item 201 is a spring of a lock. Item 203 is the body of the connector. Item 204 is a protective shield. Item 206 is a male sub-connector for the outer wire of the cable. Item 208 is insulation material. Item 212 is a central sub-connector for axial wire of the cable. Item 213 is a holder for both item 212 and spring 211. (see FIG. 2.1) Item 209 is a female sub-connector for the outer wire of the cable. Item 214 is the imaginary symmetry plane.

Item 211, 212, and 213 are electrically linked to the axial wire of the cable. The rest of items, except items 208 and 214, are electrically linked to the outer wire of the cable.

FIG. 2.1 is a cross-section, cut at the plane A-A in FIG. 2, with the view to the right after cutting.

Item 201 is the spring of the lock. Item 213 is the holder for both the central connector item 212 and spring item 211. Item 203 is the body of the connector. Item 204 is the protective shield. Item 206 is the male sub-connector for the outer wire of the cable. Item 205 is a notch that will hook the item 201 in the conjunct universal connector. Item 211 is the spring that push item 212 to make a good contact with the item 212 in the conjunct connector. Item 215 is the axis of the connector. Item 216 is a line parallel to item 215. Item 216 is going through item 205. Item 208 is insulation material. Item 209 is the female sub-connector for the outer wire of the cable. Item 210 is the push-button to release the spring item 201. Item 205 and item 201 are considered as two parts of the lock. The positions of item 205 and item 201 would be symmetrical with the symmetry plane, if item 205 were shifted along line item 216 properly.

FIG. 2.2 is a view of item 201 and item 210 from the end of the connector. Item 210 is the push button. Item 201 is the spring.

### Third Embodiment

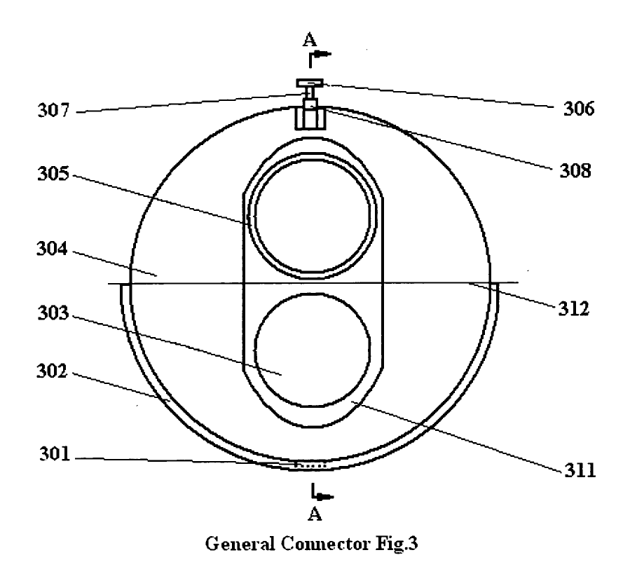

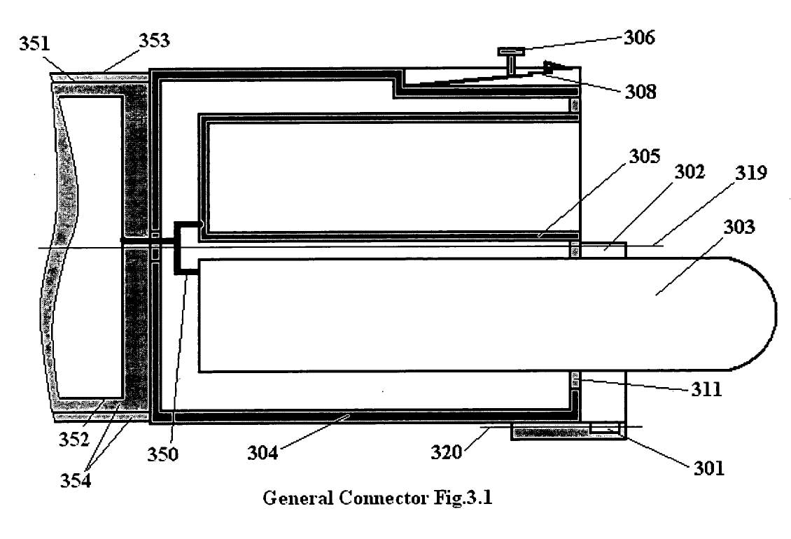

FIG. 3 is a view of the connector from one end of the cable. Item 302 is a protective shield to protect the connectors from corroding material. Item 303 is a male sub-connector for the axial wire of the cable. Item 304 is the body or shell of the universal connector. Item 305 is a female sub-connector for the axial wire of the cable. Item 306 is a push-button with a rod for pushing the spring item 308 down to release the lock. Item 308 is the spring with a hook at one end and is welded to the body of the connector at the other end.

Item 308 will be connected with item 301 (see FIG. 3.1) of the conjunct universal connector when two universal connectors are locked together. Item 312 is an imaginary symmetry plane. Item 311 is insulation material that electrically separates the axial sub-connectors from the body. Item 305 and 303 are electrically linked to the axial wire of the cable. The rest items, except item 311 and 312, are electrically linked to the outer wire of the cable.

FIG. 3.1 shows a cross section, cut at the plane A-A in FIG. 3, with the view to the right after cutting. Item 304 is the body of the connector. Item 305 is the female sub-connector for the axial wire. Item 302 is the protective shield. Item 303 is the male sub-connector for the axial wire. Item 311 is insulation material. Item 301 is the notch. Item 301 and item 308 are considered as two parts of the lock. Item 319 is the axis of the connector. Item 320 is a line parallel to item 319. Item 320 is going through item 301. The positions of item 301 and item 308 would be symmetrical with the symmetry plane, if item 301 were shifted along a line item 320 properly.

### The Fourth Embodiment

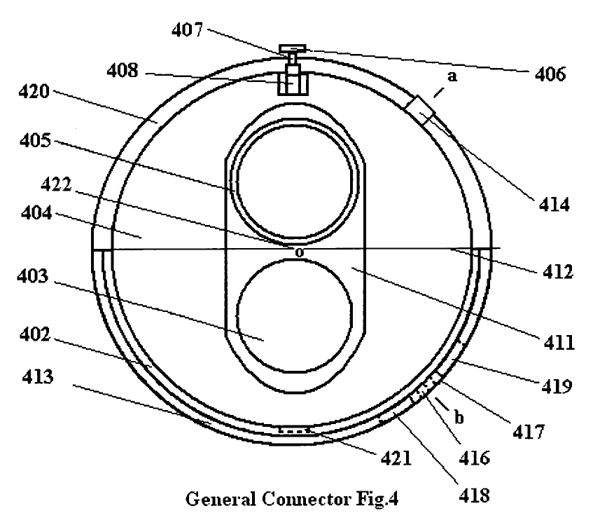

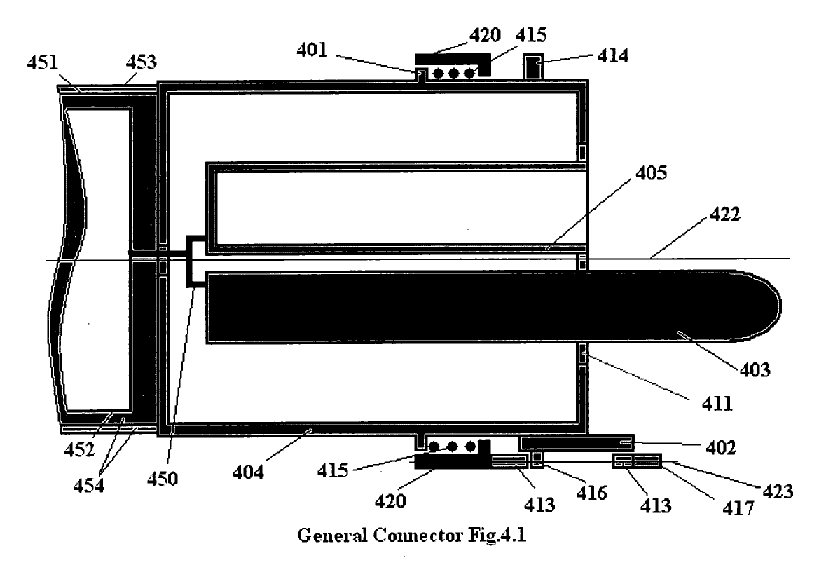

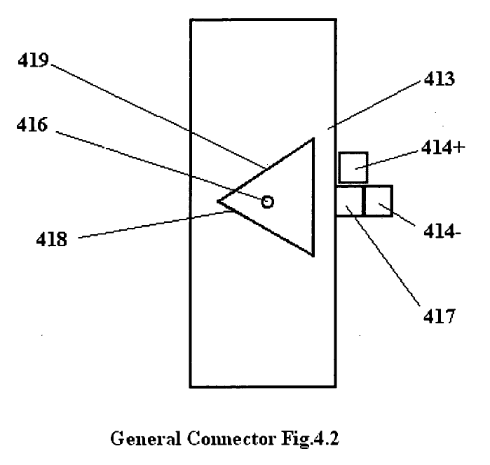

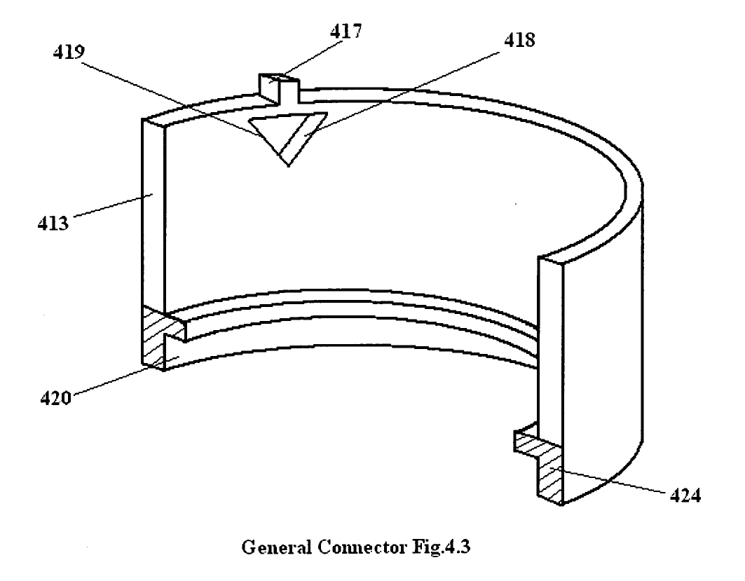

FIG. 4 is a view of the connector from one end of the cable. Item 402 is a protective shield to protect the connectors from corroding material. Item 403 is a male sub-connector for the axial wire of the cable. Item 404 is the body or shell of the universal connector. Item 405 is a female sub-connector for the axial wire of the cable. Item 406 is a push-button with a rod for pushing the spring item 408 down to release the lock. Item 408 is a spring with a hook at one end and is welded to the body of the connector at the other end. Item 412 is an imaginary symmetry plane. Item 411 is insulation material that electrically separates the axial sub-connectors from the body. Item 413 is a movable protective shield. Item 414 is a stop for the movable protective shield in the conjunct connector. Item 417 is a returning stop, protruding from item 413. Item 417 is an extension of item 413. One of the positions of item 417 and position item 414 are symmetrical with the symmetry plane. Item 420 is a ring that holds spring item 415. (see FIG. 4.1) Item 420 is a extension of item 413. Item 405 and 403 are electrically linked to the axial wire of the cable. The rest items, except item 411 and 412, are electrically linked to the outer wire of the cable.

FIG. 4.1 is cross sections cut by plane a-o and plane o-b in FIG. 4.

Item 413 is the movable protective shield. Item 414 is the stop. Item 417 is the returning stop. Item 416 is a returning guide for the movable protective shield. Item 416 is secured to item 402. Item 415 is a spring to push item 413 forwards (to the right). Item 420 is the ring. Item 404 is the body or shell of the universal connector. Item 405 is the female sub-connector for the axial wire of the cable. Item 403 is the male sub-connector for the axial wire of the cable. Item 411 is insulation material that electrically separates the axial sub-connectors from the body. Item 422 is the axis of the connector. Item 423 is a line parallel to item 422. Item 423 is going through item 417. The positions of item 417 and item 414 would be symmetrical with symmetry plane, if item 417 were shifted along line item 423 properly.

FIG. 4.2 is a bottom view of FIG. 4 for item 413, item 416, item 417, and stop item 414−. Item 414− is a stop of the conjunct connector. Items 418 and 419 are two inclined surfaces. Item 420 is the ring that holds the spring item 415. FIG. 4.2 shows the relative positions of item 413, 416, 417, and 414− when two conjunct connectors are pushed together and are locked. During the pushing, the returning stop 417 conflict with the stop 414− and the spring item 415 is getting shorter. (getting pressed harder) In order make better protection, the user should turn the movable protective shields around the body so that the returning stop item 417 will bypass stop 414−. Item 417 will move forwards (to the right) leaving item 414− behind. The new position of item 414−, relative to item 413, is now item 414+. By this time, the movable protective shields of both conjunct connectors have turned around the bodies of the connectors. The new positions of the movable protective shields now cover the seams between two protective shields.

### DETAILED DESCRIPTION

The present invention uses two methods to electrically link the outer wire of the cables. The first method is implemented by using a couple of sub-connectors: male sub-connector and female sub-connector. The first and second embodiments use this method. The second method is implemented by using the connections of the lock. All the embodiments use this method. There are two methods to electrically link the axial wire of the cables. The first method is implemented by using a couple of sub-connectors: male sub-connector and female sub-connector. The first, the third, and the fourth embodiments use this method. The second method is implemented by using central sub-connectors that are placed at the axes of the connectors. The second embodiment uses this method.

A symmetry plane is defined for a universal connector. The axis of the connector is on the symmetry plane. The axes of sub-connectors of a couple should be symmetrical with the symmetry plane.

There is at least one lock for a connector. The positions of two parts of the lock should be symmetrical with the symmetry plane.

There is a metal protective shield to prevent some chemicals that may corrode the connector. It will also minimize possible interfering radio frequency or microwave. The protective shield has a shape of half cylinder. When two universal connectors are locked together, two protective shields will combined together to form a cylinder to surround the connectors. There are two lines go from the axial sub-connectors directly to outside through the seams between two protective shields. When the tolerance is large, the lines will become two holes. The movable protective shields in the fourth embodiment will cover those holes. The movable protective shield has a returning stop formed by a protrusion. The stop has a cylinder shape. The shape of the returning stop of the movable protective shield is a cylinder. As described before, the user should turn the movable protective shields to cover the seams. When two conjunct connectors are unlocked and separated, the spring will push the movable shield forwards. In the mean time, the returning guide will force the movable protective shield return to the original position by a turning force provided by one of those inclined surfaces.

What is claimed is:

1. The universal connector that connects a coaxial cable with identical connector at the end of the cable comprising:
a) a body that is electrically linked to the outer wire of the cable;
b) a symmetry plane where the axis of said body is located;
c) a couple of symmetrical sub-connectors for a wire in the cable;
d) a lock with two symmetrical parts to keep conjunct connectors together;
e) a protective shield to protect the connector;
f) a movable protective shield to cover seams between said protective shields of two conjunct connectors;
g) a stop to keep said movable protective shield in a turned position;
h) a returning guide to force the movable protective shield to return to the original position;
i) a spring that is pushing said movable protective shield forwards;
j) a central sub-connector for the axial wire.

2. The universal connector claim 1, wherein said symmetry sub-connectors have axes that are symmetrical with said symmetry plane.

3. The universal connector claim 1, wherein the positions of said two lock parts would be symmetrical with the said symmetry plane, if one of them were shifted along a line that is parallel to the axis of said universal connector.

4. The universal connector claim 1, wherein said protective shield has a shape of half cylinder.

5. The universal connector claim 1, wherein said protective shield is on one side of said symmetry plane and closed to it.

6. The universal connector claim 1, wherein said protective shield is secured to said body of the connector.

7. The universal connector claim 1, wherein said protective shield is electrically linked to said body.

8. The universal connector claim 1, wherein said stop is secured to said body.

9. The universal connector claim 1, wherein said stop has a shape of cylinder.

10. The universal connector claim 1, wherein said movable protective shield has a shape of half cylinder.

11. The universal connector claim 1, wherein said movable protective shield has a extension as a ring around said body so that said movable protective shield can move around the axis of said body.

12. The universal connector claim 1, wherein said movable protective shield has an extension as a returning stop, protruding from said movable protective shield.

13. The universal connector claim 12, wherein the position of said returning stop and the position of said stop in claim 1 would be symmetrical with said symmetry plane if one of them were shifted along a line that is parallel to the axis of said universal connector.

14. The universal connector claim 1, wherein said movable protective shield has at least a inclined surface to cooperate with said returning guide in the returning of said movable protective shield to the original position.

15. The universal connector claim 1, wherein said central sub-connector is located at the axis of the connector.
